(19) United States
(12) Patent Application Publication
(10) Pub. No.: US 2019/0331634 A1
(43) Pub. Date: Oct. 31, 2019

(54) SOLID ELECTROLYTE BODY FOR GAS SENSOR ELEMENT, PRODUCTION METHOD THEREOF AND GAS SENSOR ELEMENT

(71) Applicant: DENSO CORPORATION, Kariya-city, Aichi-pref. (JP)

(72) Inventors: Mitsuhiro YOSHIDA, Kariya-city, Aichi-pref. (JP); Satoshi SUZUKI, Kariya-city, Aichi-pref. (JP)

(21) Appl. No.: 16/349,765

(22) PCT Filed: Nov. 13, 2017
(86) PCT No.: PCT/JP2017/040684

§ 371 Date: May 14, 2019

(30) Foreign Application Priority Data
Nov. 15, 2016 (JP) 2016-222319

(51) Int. Cl. G01N 27/407; G01N 27/409; C04B 35/488; C04B 35/626; C04B 35/64

(52) U.S. Cl. CPC G01N 27/4073; H01B 1/08; C04B 35/488; C04B 35/4885; C04B 35/6261; C04B 35/6264; C04B 35/62655; C04B 35/62695; C04B 35/64; C04B 2235/3246; C04B 2235/3225; C04B 2235/3217; C04B 2235/3418; C04B 2235/5445; C04B 2235/604; C04B 2235/656; G01N 27/409

(57) ABSTRACT

A solid electrolyte body for a gas sensor element constituted by solid electrolyte particles made of zirconia containing a stabilizer has a solid electrolyte phase in which a large number of the solid electrolyte particles are aggregated, and, in the solid electrolyte phase, pairs of the solid electrolyte particles adjoining each other do not have a particle interface impurity layer between their particle interfaces, and the particle interfaces directly contact with each other.

### CROSS-REFERENCE TO RELATED APPLICATION

This application is based on and claims the benefit of priority from earlier Japanese Patent Application No. 2016-222319 filed Nov. 15, 2016, the entire content of the patent application of which is incorporated herein by reference.

### TECHNICAL FIELD

The present disclosure relates to a solid electrolyte body for a gas sensor element used for a gas sensor element for detecting a specific gas component, a production method thereof, and a gas sensor element using the same.

### BACKGROUND ART

In an exhaust system and the like of an internal combustion engine, a gas sensor is often disposed to detect oxygen concentration, air-fuel ratio and the like in an exhaust gas, and to feed the detected results back to a combustion control system of the internal combustion engine. Such a gas sensor is provided with a gas sensor element using a solid electrolyte body having oxide ionic conductivity. For example, a pair of electrodes are provided on the inner and outer surfaces of the solid electrolyte body, where one of the electrodes is exposed to exhaust gas, and oxygen concentration is detected from the electromotive force generated between the pair of electrodes.

In recent years, exhaust gas regulations of vehicle engines have been tightened, and concurrently further improvements in fuel consumption are called upon. For example, combustion control at the time of starting an engine is important to reduce emissions, and combustion properties at the time of starting an engine can be improved by activating the gas sensor at an earlier point. However, since the gas sensor element is activated early, at the time of starting an engine when the temperature of the exhaust gas is low, stress may be generated in the solid electrolyte body and the electrolyte body may develop cracks and the like due to the rapid temperature rise.

Moreover, as hybrid vehicles and idling stop vehicles restart repeatedly, power consumption of a heater increases and causes reduction of fuel efficiency. As such, it is expected that the control of combustion behavior at the time of starting an engine will be improved while preventing damage to the solid electrolyte body and suppressing reduction of fuel efficiency by improving low temperature activation of the gas sensor element.

Patent Literature 1 discloses a partially stabilized zirconia porcelain comprising zirconia and yttria, where the content of zirconia is 89 to 97 mol %, the content of yttria is 11 to 3 mol %, and the content of impurities other than zirconia and yttria is 0.1% by mass or less. By limiting the content of impurities other than zirconia and yttria, for example, alumina or silica, to the range of 0.1% by mass or less, it is possible to strike a balance between the stability and the electrical conductivity of the crystal.

### CITATION LIST

### Patent Literature

[PTL 1]: JP 5205245 B

### SUMMARY OF THE INVENTION

In the gas sensor element, the detection sensitivity of the gas sensor element increases by improving ionic conductivity of the solid electrolyte body, and it becomes possible to detect a specific gas component in a state where the element temperature is lower. In the constitution of Patent Literature 1, since a predetermined amount of yttria is added to zirconia and impurities are contained in a range of 0.1% by mass or less (for example, 0.02 to 0.09% by mass), it was found that there is a limit to improving ionic conductivity and desired low temperature starting properties cannot be obtained.

The objects of the present disclosure are to provide a solid electrolyte body for a gas sensor element where ionic conductivity is further improved to make activation at a lower temperature possible, a production method thereof, and a gas sensor using the solid electrolyte body.

### Solution to Problem

One aspect of the present disclosure is,

a solid electrolyte body for a gas sensor element constituted by solid electrolyte particles made of zirconia containing a stabilizer, the solid electrolyte body having a solid electrolyte phase in which a large number of the solid electrolyte particles are aggregated,

wherein, in the solid electrolyte phase, pairs of the solid electrolyte particles adjoining each other do not have a particle interface impurity layer between their particle interfaces, and the particle interfaces directly contact with each other.

Another aspect of the present disclosure is a method of producing the solid electrolyte body for a gas sensor element, comprising the steps of:

a pulverizing step of pulverizing a raw material of the solid electrolyte particles;

a slurrying step of mixing the pulverized raw material powder with a solvent to form a slurry;

a filtering step of separating impurities together with the solvent from the raw material powder by performing centrifugal separation on the obtained slurry; and

a molding step of molding the separated raw material powder into a molded body.

Still another aspect of the present disclosure is a gas sensor element using the solid electrolyte body for a gas sensor element, wherein the gas sensor element is provided with a sensor body portion having the solid electrolyte body for a gas sensor element and a pair of electrodes, and

the solid electrolyte body for a gas sensor element has a measuring electrode of the pair of electrodes on a first surface contacting a gas to be measured containing a specific gas component, and a reference electrode of the pair of electrodes on a second surface contacting a reference gas.

### Advantageous Effects of the Invention

In the solid electrolyte body for a gas sensor element, the particle interfaces of two mutually adjoining solid electrolyte particles are in direct contact with each other in the solid electrolyte phase. That is, since a particle interface impurity layer which is an inhibiting factor for ionic conduction does not exist in the particle interfaces of the solid electrolyte particles, ionic conduction between adjoining particle interfaces is promptly performed, and ionic conductivity is improved. Since a gas sensor element using such a solid electrolyte body can be activated at a lower temperature, it is used, for example, to control combustion of an engine, and improves controllability at the time of starting an engine and contributes to suppress exhaust emissions. Moreover, since a rapid temperature rise is no longer necessary, damage to the solid electrolyte body is prevented, or power consumption of a heater at the time of restart is reduced and therefore fuel efficiency improves.

Such a solid electrolyte body for a gas sensor element can be produced by undergoing a filtering step after performing a pulverizing step of a raw material and a slurrying step. In the filtering step, the raw material powder is separated from the solvent by centrifugation, and the trace amount of impurities contained in the slurry remains in the solvent, and therefore a raw material powder containing no impurities can be obtained. By firing a molded body obtained in the following molding step, a solid electrolyte body having no particle interface impurity layer in the interfaces of the solid electrolyte particles, where the particle interfaces are in direct contact with each other, can be obtained.

As such, according to the above aspect, it is possible to create a solid electrolyte body for a gas sensor element having improved ionic conductivity and being capable of activation at a lower temperature. Moreover, it is possible to provide a production method thereof and a gas sensor using the same.

### BRIEF DESCRIPTION OF THE DRAWINGS

The object mentioned above and other objects, features and advantages of the present disclosure shall become more evident by the following detailed description with reference to the accompanying drawings. The drawings are as follows:

FIG. 1 is a view schematically showing a structure of a solid electrolyte body for a gas sensor element in a first embodiment of the present disclosure;

FIG. 2 is a schematic view for explaining the relationship between particle interfaces and ionic conductivity of the solid electrolyte phase of the solid electrolyte body for a gas sensor element in a first embodiment of the present disclosure;

FIG. 3 is a partial cross-sectional view showing a schematic configuration of a gas sensor element where the solid electrolyte body for a gas sensor element is applied in a first embodiment of the present disclosure;

FIG. 4 is a partial cross-sectional view showing a schematic configuration of the gas sensor element where the solid electrolyte body for a gas sensor element is applied in a first embodiment of the present disclosure;

FIG. 5 is a STEM photograph (20,000× magnification) showing a structure of the solid electrolyte body for a gas sensor element in an example of the present disclosure;

FIG. 6 is a STEM photograph (10,000× magnification) showing a structure of the solid electrolyte body for a gas sensor element in an example of the present disclosure, and is an enlarged photograph of region VI of FIG. 5.

FIG. 7 is a STEM photograph (20,000× magnification showing a structure of a conventional solid electrolyte body for a gas sensor element in an example of the present disclosure;

FIG. 8 is a STEM photograph (10,000× magnification) showing a structure of the solid electrolyte body for a gas sensor element in an example of the present disclosure, and is an enlarged photograph of region VIII of FIG. 7; and

FIG. 9 is a view schematically showing the relationship between a structure and ionic conductivity of the conventional solid electrolyte body for a gas sensor element in an example of the present disclosure.

### DESCRIPTION OF THE EMBODIMENT

### First Embodiment

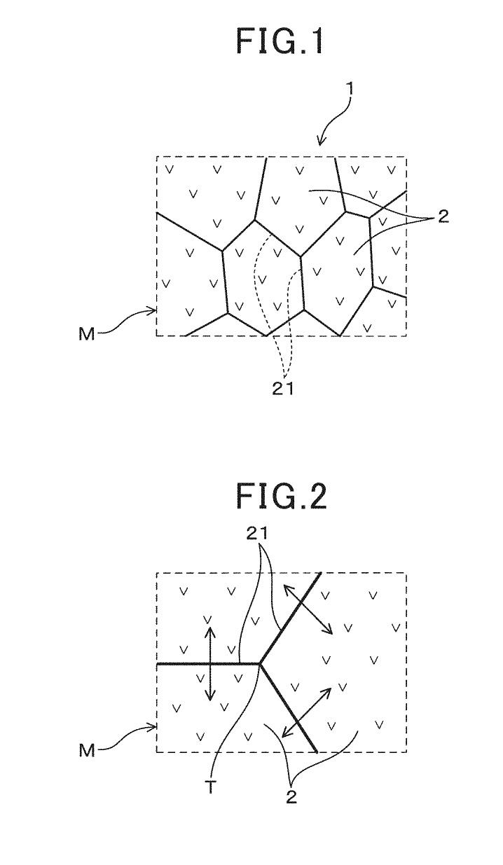

An embodiment relating to a solid electrolyte body for a gas sensor element and a gas sensor element using the same shall be described with reference to FIG. 1 to FIG. 4. As shown in FIG. 1, a solid electrolyte body for a gas sensor element (hereinafter abbreviated as solid electrolyte body when appropriate) 1 is constituted by solid electrolyte particles 2 made of zirconia containing a stabilizer. Specifically, the solid electrolyte body 1 has a solid electrolyte phase M formed by aggregating a large number of solid electrolyte particles, and the solid electrolyte phase M is a polycrystalline phase where a large number of solid electrolyte particles 2 are continuously disposed in contact with one another. In the present aspect, the solid electrolyte body 1 is constituted only by the solid electrolyte phase, and does not contain particles other than the solid electrolyte particles 2.

As schematically shown in FIG. 2, in the solid electrolyte phase M, pairs of mutually adjoining solid electrolyte particles 2 do not have a particle interface impurity layer between their particle interfaces 21, and the particle interfaces 21 are in direct contact with each other. A large number of the solid electrolyte particles 2 are crystal particles of zirconia each containing a stabilizer, and have ionic conductivity between adjoining crystal particles via particle interfaces 21 in direct contact.

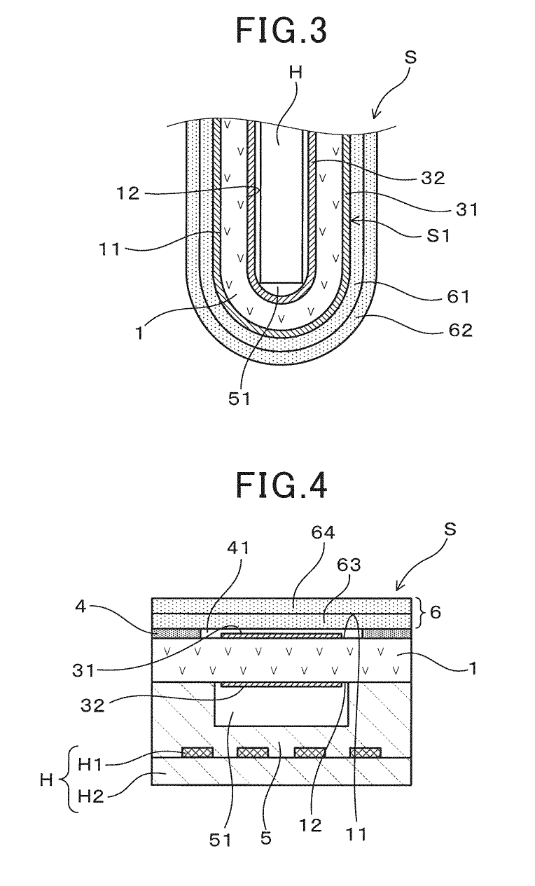

The solid electrolyte body 1 constitutes an element body portion S1 of the gas sensor element S shown in FIG. 4 and FIG. 3. The element body portion S1 has the solid electrolyte body 1, and a pair of measuring electrodes 31 and a reference electrode 32. The measuring electrodes 31 are formed on a first surface 11 of the solid electrolyte body 1, and the reference electrode 32 is formed on a second surface 12 of the solid electrolyte body 1. A detailed constitution of the gas sensor element S shall be described later.

The solid electrolyte particles 2 comprises stabilized or partially stabilized zirconia containing at least one selected from, for example, yttria, calcia, magnesia and scandia as a stabilizer. The stabilizer stabilizes the crystal structure of zirconia and improves the mechanical and thermal properties. Partially stabilized zirconia containing yttria is preferably used as a stabilizer to develop excellent ionic conductivity. The content of the stabilizer is usually selected in the range of 3 mol % to 11 mol % so that desired strength and ionic conductivity can be obtained. Although the ionic conductivity improves as the content of the stabilizer increases, but the bending strength tends to decrease in the case, and therefore the content of the stabilizer is preferably in the range of 4.5 mol % to 8 mol %.

In FIG. 1, the solid electrolyte phase M is constituted such that a large number of the solid electrolyte particles 2 are densely compacted with one another without gaps. Two adjoining solid electrolyte particles 2 are in direct contact with each other in the particle interfaces 21, and improve the ionic conductivity between the solid electrolyte particles 2. Two particle grain boundaries where two solid electrolyte particles 2 adjoin do not substantially contain impurities derived from raw materials or others and a particle interface layer containing impurities is not formed. The same holds true for particle interface triple point T (see, for example, FIG. 2) surrounded by three solid electrolyte particles 2, and the particle interface impurity layer is substantially not present.

Here, the structure where the particle interfaces 21 are in direct contact means a state where elements other than the constituting elements (for example, Zr, Y and O) of zirconia containing a stabilizer are not quantified when element analysis is performed on a particle interface portion contacting the particle interfaces 21. Specifically, it means a state where the content of the particle interface impurities is less than the quantitation limit (for example, less than 1% by mass), preferably less than the detection limit (for example, less than 0.1% by mass), when an arbitrary point in a range, where a two-particle particle interface or a particle interface triple point is formed, is evaluated by TEM-EDX quantitative analysis to be described later. More preferably, for example, when at least 9 out of 10 arbitrary points are less than the detection limit, it is possible to say that the particle interfaces are in direct contact.

In the solid electrolyte body 1, oxygen vacancies are formed in the crystal structure of the solid electrolyte phase M by adding a stabilizer, and the solid electrolyte body 1 exhibits oxide ionic conductivity. At this time, since the particle interfaces 21 of the solid electrolyte particles 2 are in direct contact with each other without interposing the particle interface impurity layer, as shown by the arrows in FIG. 2, migration of oxide ions from the particle interfaces 21 of the solid electrolyte particles 2 to the adjoining solid electrolyte particles 2 easily occurs, and ionic conductivity is improved. The solid electrolyte body 1 preferably has, for example, an ionic conductivity at 300° C. in the range of 6×10⁻⁶ S/cm to 9×10⁻⁶ S/cm. When the ionic conductivity is 6×10⁻⁶ S/cm or more, the output sensitivity of the gas sensor element is enhanced, and a desired sensor output can be obtained at a relatively low temperature. The output sensitivity improves as the ionic conductivity increases. However, when the content of a stabilizer increases to enhance the ionic conductivity, the bending strength tends to drop, and therefore it is possible to strike a balance between output sensitivity and bending strength by selecting the ionic conductivity in the range of 9×10⁻⁶ S/cm or less.

Specifically, it is desirable that the solid electrolyte body 1 has a four point bending strength by a four point bending test similar to JIS R 1601 of 250 MPa or more, preferably 300 MPa or more. It is possible to achieve a four point bending strength of 250 MPa or more by adequately selecting the type and content of the stabilizer, and development of cracks at the time of assembling a sensor can be prevented.

In such a solid electrolyte body 1, a pair of electrodes 31 and 32 can be disposed on the first and second surfaces 11 and 12 thereof, and the element body portion S1 of the gas sensor element S can be constituted. The gas sensor element S can be disposed, for example, in an exhaust gas passage of an internal combustion engine, and be used to detect a specific gas component contained in an exhaust gas to be measured. Specifically, it is possible to constitute an oxygen sensor and an air-fuel ratio sensor to detect oxygen concentration, air-fuel ratio and the like of the exhaust gas.

As an example, as shown in FIG. 3, the gas sensor element S can be a cup-shaped gas sensor element S. The gas sensor element S has a cup-shaped solid electrolyte body 1 having a bottomed cylindrical shape, and a pair of measuring electrodes 31 and a reference electrode 32 are provided on each of the opposing inner and outer surfaces, respectively, to constitute the element body portion S1. In the solid electrolyte body 1, the outer surface is the first surface 11 on the side of the exhaust gas to be measured, and the inner surface is the second surface 12 on side of the reference gas. The internal space of the solid electrolyte body 1 is a reference gas chamber 51, and the reference electrode 32 is formed in the inner surface which is the second surface 12 facing the reference gas chamber 51. The reference gas chamber 51 communicates with the outside, and atmospheric air serving as a reference gas is introduced. Moreover, a rod-shaped heater portion H is inserted and disposed coaxially with the gas sensor element S in the reference gas chamber 51.

On the other hand, the measuring electrodes 31 are formed in the outer surface which is the first surface 11 of the solid electrolyte body 1, and by covering the outside thereof, a first protective layer 61 made of a porous ceramic layer, and a second protective layer 62 protecting the surface of the first protective layer are sequentially formed. The second protective layer 62 is made of, for example, a porous ceramic layer having a larger porosity, and captures poisoning substances and the like in the exhaust gas and suppresses the poisoning substances to reach the element body portion S1. On the first surface 11 of the solid electrolyte body 1, a lead portion and a terminal electrode (not shown in the figures) connected to the measuring electrodes 31 are formed.

The gas sensor element S is usually mounted so that the element body portion S1 is positioned in the exhaust gas passage, in a state where the outer periphery thereof is protected by a cover body (not shown in the figures). When the exhaust gas from the internal combustion engine reaches the element body portion S1, an electromotive force is generated between the pair of measuring electrodes 31 and the reference electrode 32 depending on the concentration of oxygen contained in the exhaust gas, and the electromotive force can be detected as a sensor output.

At this time, the sensor output has temperature dependency as mentioned above, but the solid electrolyte body 1 constituting the element body portion S1 has high ionic conductivity, and therefore the detection sensitivity rises. This makes it possible to detect the oxygen concentration in a state where the temperature of the element body portion S1 heated by the heater portion H is relatively low, and it is possible to control the operation of the internal combustion engine by feedback. Therefore, the controllability at the time of starting an engine improves, and it is possible to strike a balance between suppressing emissions and improving fuel efficiency.

Alternatively, as another example, as shown in FIG. 4, the gas sensor element S can be of a laminated-type. The gas sensor element S has a pair of measuring electrodes 31 and a reference electrode 32, respectively, on the first and second surfaces 11 and 12 facing each via a sheet-shaped solid electrolyte body 1. The first surface 11 is positioned on the side of the exhaust gas to be measured, and the second surface 12 on the side of the reference gas side, and are formed by laminating, respectively, an insulator layer 4 forming a measured-gas chamber 41 on the side of the measuring electrodes 31, and an insulator layer 5 forming a reference gas chamber 51 on the side of the reference electrode 32. On the surface of the insulator layer 4 on the side of the gas to be measured, a porous layer 63 and a shielding layer 64 are sequentially laminated to constitute a diffusion resistance layer 6. Atmospheric air serving as a reference gas is introduced into the reference gas chamber 51 from the outside, and an exhaust gas is introduced into the measured-gas chamber 41 via the diffusion resistance layer 6.

The measuring electrodes 31 and the reference electrode 32 are made of precious metal electrodes such as Pt. The insulator layers 4 and 5 and the diffusion resistance layer 6 are made of ceramic sheet such as alumina. A hole portion serving as a measured-gas chamber 41 is formed in the insulator layer 4 at a position facing the measuring electrodes 31, and a groove portion serving as the reference gas chamber 51 is formed in the insulator layer 5 at a position facing the reference electrode 32. The diffusion resistance layer 6 comprises a gas permeable porous layer 61 and a gas impermeable shielding layer 62, and is constituted by covering the surface of the porous layer 63 in the laminating direction (the upper surface in the figures) with the shielding layer 64. The porous layer 63 is, for example, a porous ceramics layer conditioned to have a porosity of approximately 60 to 80%, and the shielding layer 64 is made of a dense ceramic layer.

As such, the exhaust gas passes through the diffusion resistance layer 6 having a predetermined diffusion resistance and is introduced into the element body portion S1. That is, the introduction of the exhaust gas from the upper surface side covered with the shielding layer 64 is blocked, and the introduction of the exhaust gas is limited only from the side surface of the porous layer 63, so that the amount of the exhaust gas introduced can be controlled. At this time, a limiting current flows between the pair of measuring electrodes 31 and the reference electrode 32 depending on the oxygen concentration contained in the exhaust gas, and the air-fuel ratio can be detected on the basis of the limiting current.

Moreover, the gas sensor element S is laminated on the insulator layer 5 on the side of the reference gas, and is integrally provided with the heater portion H and heats the element body portion S1 to a desired temperature. The heater portion H comprises an insulator layer H2 made of ceramic sheet such as alumina, and a heater electrode H1 formed on the surface thereof. The heater electrode H1 is buried between the insulator layer H2 and the insulator layer 5.

In this constitution as well, the solid electrolyte body 1 constituting the element body portion S1 has high ionic conductivity, and therefore the detection sensitivity is high. This makes it possible to detect the air-fuel ratio from a state where the temperature of the element body portion S1 heated by the heater portion H is relatively low, and it is possible to control the operation of the internal combustion engine by feedback. Therefore, the controllability at the time of starting an engine improves, and it is possible to strike a balance between suppressing emissions and improving fuel efficiency.

(Method of Producing Solid Electrolyte Body for Gas Sensor Element)

Such solid electrolyte body 1 can be produced by the following steps:

### That is,

a pulverizing step of pulverizing a raw material of the solid electrolyte particles 2;

a slurrying step of mixing the pulverized raw material powder with a solvent to form a slurry are performed,

and more preferably, a filtering step of separating impurities together with the solvent from the raw material powder by performing centrifugal separation on the obtained slurry is performed. Then, a molding step of molding the separated raw material powder into a molded body is performed, and the obtained molded body is fired to form a solid electrolyte body 1. Each of these steps is hereinafter described.

First, in the pulverizing step, solid electrolyte particles 2 as a starting material is mixed with high purity zirconia powder and high purity yttria powder and the mixture is pulverized. As for a pulverizing method, it is possible to adopt a dry or wet pulverizing method using a pulverizing apparatus using zirconia cobblestones or alumina cobblestones as media. Preferably, zirconia cobblestones are used. In particular, in the case where a filtering step is not performed to be described later, mixing of impurities derived from the media can be suppressed by using high purity zirconia cobblestones. It is desirable that the purity of the raw material powder be, for example, 99.9% by mass or more, and preferably 99.99% by mass or more. Regarding the purity of the zirconia cobblestones, it is desirable that, for example, the ratio of zirconia containing a stabilizer be 99.0% by mass or more, and preferably 99.5% by mass or more. The raw material powder or the zirconia cobblestones have a higher effect of suppressing the formation of a particle interface impurity layer in the solid electrolyte phase M when the purity is higher. When alumina cobblestones are used, although it is not necessarily limited, it is desirable that similar purities are attained.

The mixed and pulverized raw material is further mixed using a solvent to form a slurry in the slurrying step. It is desirable that the mixed powder before slurrying has, for example, an average particle diameter of approximately 0.2 μm to 0.8 μm, and a content of impurities of less than 0.02% by mass, preferably 0.01% by mass or less. As for the solvent added to the mixed powder, for example, water or an aqueous solvent containing water is preferably used. The slurry is obtained by adding an appropriate amount of the aqueous solvent to the raw material powder and mixing the mixture for a sufficient time period. Alternatively, it is possible to use an organic solvent, for example, an alcohol solvent such as ethanol.

The obtained slurry is sufficiently diluted by further adding the aqueous solvent used for slurrying and is subjected to filtering using a centrifugal separator. The added solvent is preferably prepared such that the amount of the solvent in the diluted solution is, for example, twice or more larger than the amount of the solvent in the slurry, for example, of approximately three times larger. As a result, the raw material powder is homogeneously dispersed in the diluted solution, and trace amounts of impurities derived from the raw material powder or the zirconia cobblestones in the pulverizing apparatus contained in the slurry are easily dispersed in the solvent.

After centrifugation, it is possible to remove the trace amount of impurities together with the solvent by separating the raw material powder from the solvent. By going through the filtering step, it is possible to reduce the content of the impurities to a state where impurities are substantially not included (that is, less than the quantitation limit, and preferably less than the detection limit).

Further, in the case where the raw material powder and the zirconia cobblestones have purity in the preferable range mentioned above, and the mixed powder before slurrying is in a state hardly containing impurities, even if the filtering step is omitted, it is possible to obtain effects of suppressing formation of the particle interface impurity layer. Alternatively, in the case of using alumina cobblestones, it is possible to obtain similar effects by performing the filtering step to achieve a state where impurities are hardly contained.

After filtering, the solvent is added again to the separated raw material powder. As for the solvent, an aqueous solvent similar to the one used in the slurrying step can be used, and the same amount of the solvent as used for slurrying is added to form a slurry. The obtained slurry is converted to dried powder by, for example, spray drying, and is molded to a predetermined shape using an ordinary press method.

The molded body obtained in the molding step is fired at a firing temperature of, for example, 1,300° C. to 1,500° C. to obtain a solid electrolyte body 1.

### EXAMPLES

### Example 1

A solid electrolyte body 1 was produced by performing a pulverization step, slurrying step, and filtering step as follows. In the pulverizing step, high purity zirconia powder (having a purity of 99.99% by mass or more) and high purity yttria powder (having a purity of 99.99% by mass or more) were used as starting materials. As shown in Table 1, yttria powder was added to the zirconia powder so as to have a content of 4.5 mol % to prepare a raw material powder, and was mixed and pulverized by a dry process using a pulverizing apparatus using high purity zirconia cobblestones (having a purity of 99.5% by mass or more) as media. Average particle diameter of the raw material powder after pulverizing was 0.6 μm and the content of impurities in the raw material powder was 0.01% by mass or less.

In the following slurrying step, water as a solvent was added to the mixed and pulverized raw material powder and the mixture was mixed for 6 hours to form a slurry. Then, in the molding step, the obtained slurry was sprayed and dried by spray drying, and a granular dry powder was obtained. Then, the granular powder was molded in a cup-shaped by a rubber press method, and grinding was performed thereto to obtain a cup-shaped molded body similar to that shown in FIG. 3. The obtained molded body was fired at 1,400° C. to obtain a solid electrolyte body 1 containing partially stabilized zirconia as a main component (that is, Example 1).

### Example 2

Similarly to Example 1, after performing a pulverizing step and slurrying step, a filtering step was performed. As shown in Table 1, a pulverizing step and slurrying step were performed in a similar manner except that the content of the yttria powder in the raw material powder was changed to 6 mol %. In the filtering step, the obtained slurry was diluted by adding water, and then the diluted slurry was centrifuged. The dilution conditions were as follows: The amount of water in the diluted slurry was tripled, and the vessel containing the diluted slurry was set in a centrifugal separator and centrifuged at a rotation speed of 10,000 rpm for 2 minutes. Then, the separated supernatant liquid was removed, water was added again and mixed to obtain a slurry. The amount of water added was determined to be the same as the amount added in the slurrying.

Then, in the same manner, in the molding step, the obtained slurry was made into a granular dry powder by spray drying and a cup-shaped molded body was obtained by a rubber press method. The obtained molded body was fired at 1,400° C. to obtain a cup-shaped solid electrolyte body 1 containing partially stabilized zirconia as a main component (that is, Example 1).

### Examples 3 to 6

As shown in Table 1, a pulverizing step, slurrying step and molding step were performed in the same manners as those in Example 1 except that the content of the yttria powder in the raw material powder was changed to 6 mol %, and similarly, the obtained molded body was fired to obtain a cup-shaped solid electrolyte body 1 (Example 3: Level A3).

A pulverizing step, slurrying step and molding step were performed in the same manners as those in Example 1 except that the content of the yttria powder in the raw material powder was changed to 8 mol %, and similarly, the obtained molded body was fired to obtain a cup-shaped solid electrolyte body 1 (that is, Example 4).

A pulverizing step, slurrying step, filtering step and molding step were performed in the same manners as those in Example 2 except that the content of the yttria powder in the raw material powder was changed to 6 mol % and the media of the pulverizing apparatus was changed to alumina cobblestones. Similarly, the obtained compact was fired to obtain a cup-shaped solid electrolyte body 1 (that is, Example 5).

A pulverizing step, slurrying step, filtering step and molding step were performed in the same manners as those in Example 2 except that the content of the yttria powder in the raw material powder was changed to 8 mol %. Similarly, the obtained molded body was fired to obtain a cup-shaped solid electrolyte body 1 (that is, Example 6).

### Comparative Example 1

A pulverizing step, slurrying step, and molding step were performed in the same manners as those in Example 1 except that the content of the yttria powder in the raw material powder was changed to 6 mol % and the media of the pulverizing apparatus was changed to alumina cobblestones. Similarly, the obtained molded body was fired to obtain a cup-shaped solid electrolyte body 1 (that is, Comparative Example 1).

TABLE 1

| | | | | | | | Four Point | | |
|---|---|---|---|---|---|---|---|---|---|
| Examples | | | | | Grain | Ionic | Bending | | |
| Comparative | Y₂O₃ Amount | Pulverizing | | Direct | Boundary | Conductivity | Strength | Sensor | |
| Example | (mol %) | Method | Filtering | Contact | Impurity *1) | (S/cm) | (MPa) | Properties (V) | Determination |
| Examples 1 | 4.5 | Zirconia | Absent | Present | 0%(9/10) | 6.3 × 10⁻⁶ | 320 | 0.6 | Pass |
| | | Cobblestones | | | | | | | |
| Examples 2 | 6 | Zirconia | Present | Present | 0%(10/10) | 7.3 × 10⁻⁶ | 310 | 0.8 | Pass |
| | | Cobblestones | | | | | | | |
| Examples 3 | 6 | Zirconia | Absent | Present | 0%(9/10) | 6.8 × 10⁻⁶ | 330 | 0.7 | Pass |
| | | Cobblestones | | | | | | | |
| Examples 4 | 8 | Zirconia | Absent | Present | 0%(9/10) | 8.7 × 10⁻⁶ | 270 | 0.8 | Pass |
| | | Cobblestones | | | | | | | |
| Examples 5 | 6 | Alumina | Present | Present | 0%(9/10) | 6.5 × 10⁻⁶ | 350 | 0.6 | Pass |
| | | Cobblestones | | | | | | | |
| Examples 6 | 8 | Zirconia | Present | Present | 0%(10/10) | 8.9 × 10⁻⁶ | 260 | 0.9 | Pass |
| | | Cobblestones | | | | | | | |
| Comparative | 6 | Alumina | Absent | Absent | 12% | 2.6 × 10⁻⁶ | 400 | 0.5 | Fail |
| Example 1 | | Cobblestones | | | | | | | |

*1): Figures in parentheses show the number of points out of the 10 points quantitatively analyzed showing quantities less than the detection limit.

(Assessment by STEM-EDX Quantitative Analysis)

Regarding each of the solid electrolyte bodies 1 of Examples 1 to 6 and Comparative Example 1 obtained in manners described above, composition of a particle interface layer was examined with an energy dispersive X-ray analyzer (hereinafter referred to as EDS) using a scanning transmission electron microscope (hereinafter referred to as STEM). An observation part of a test piece was processed with a focusing ion beam (hereinafter referred to as FIB) apparatus (that is, “VIOLA” manufactured by FEI Company Japan Ltd.), and a thin film sample having a thickness of 0.1 μm was obtained. Next, the thin film sample was observed using STEM (that is, “JEM-2800” manufactured by JEOL Ltd.), and a STEM photograph was obtained.

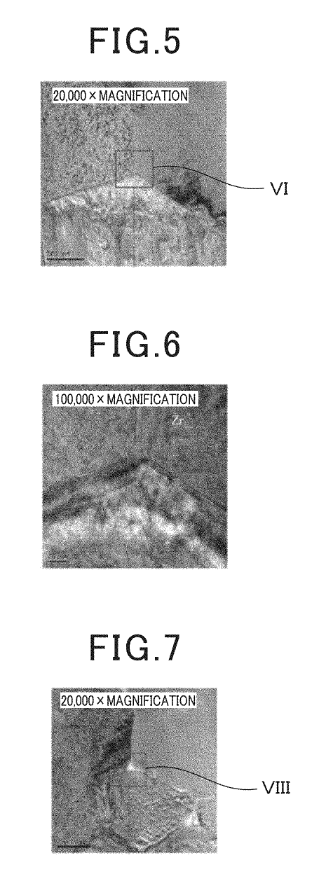

A STEM photograph of Example 2 (that is, 20,000× magnification) as a representative example thereof is shown in FIG. 5. Moreover, as FIG. 6 shows an enlarged photograph of region VI of a portion thereof (that is, 100,000× magnification), a state where particle interfaces 21 of the solid electrolyte particles 2 are in close contact with each other was observed, and a corner portion serving as a boundary between three solid electrolyte particles 2 in particle interface triple point was formed, and no particle interface impurity layer was found.

Moreover, regarding two-particle particle interface at which two solid electrolyte particles 2 contact, 10 arbitrary points were selected and presence or absence of direct contact of particles was determined. Specifically, STEM-EDX quantitative analysis was performed on the selected 10 points, and compositions of Al component, Si component, Y component, and Zr component were quantitatively determined in terms of oxides. For example, regarding a plurality of analysis points 1 to 5 including two-particle particle interface in a region shown in FIG. 6, the quantitative results are shown in Table 2 where components other than the Y component and the Zr component were less than the detection limit (for example, less than 0.1% by mass) regardless of the analysis position. In this case, it can be considered that impurities are not present in the particle interface of two solid electrolyte particles 2. Further, quantitative analysis was performed at 10 arbitrary points, and when the determined quantities of atoms other than Zr, Y and O were less than the detection limit at 9 points or more in the 10 points, the content of particle interface impurities was determined to be 0%. At this time, it was determined that the solid electrolyte phase M did not have a particle interface impurity layer, that is, it was determined that direct contact was present. In other cases it was determined that there was no direct contact. The results are shown together in Table 1.

TABLE 2

| Analysis | Analysis | Component Composition (Mass %) | | |
|---|---|---|---|---|
| Point | Position | Al₂O₃ | Y₂O₃ | ZrO₂ |
| 1 | Within Particle | — | 14.9 | 85.1 |
| 2 | Within Particle | — | 15.1 | 84.9 |
| 3 | Within Particle | — | 14.8 | 85.2 |
| 4 | Grain Boundary | — | 15.9 | 84.1 |
| 5 | Grain Boundary | — | 15.8 | 84.2 |

(Assessment of Ionic Conductivity)

Regarding the solid electrolyte body 1 of each of Examples 1 to 6 and Comparative Example 1, the ionic conductivity was measured as follows. Each solid electrolyte body 1 was cut to an appropriate size to prepare test pieces and a pair of electrodes made of Pt were formed on both sides of the test piece by screen printing. The ionic conductivity of the obtained test piece was measured at 300° C. The results are shown together in Table 1.

As is evident from Table 1, in each of Examples 1 to 6, the content of the particle interface impurities was 0%, and it was determined that direct contact was present. Moreover, in each of Examples 1 to 6, the ionic conductivity at 300° C. was 6×10⁻⁶ S/cm, and a good result was obtained. On the other hand, in Comparative Example 1, the content of the particle interface impurities was 12% and direct contact was determined to be absent. Moreover, the ionic conductivity was 2.6×10⁻⁶ S/cm, which is lower than those of Examples 1 to 6. Further, in Examples 1, and 3 to 5, there were 9 points less than the detection limit, out of 10 points, but particle interface impurities were also less than the quantitation limit for the remaining 1 point, and impurities of 1% or more as shown in Comparative Example 1 were not detected.

(Assessment by Four Point Bending Test)

Moreover, regarding the solid electrolyte body 1 of each of Examples 1 to 6 and Comparative Examples 1, a four point bending test similar to JIS R 1601 was performed. First, assessment samples were prepared by cutting each solid electrolyte body 1 out to a width of approximately 5 mm and a length of approximately 45 mm. Four point bending tests were performed for 10 times on these assessment samples for each solid electrolyte body 1, and an average value was calculated. The results are shown together in Table 1.

As is evident from Table 1, in each of Examples 1 to 6, the four-point bending strength is 250 MPa or more, and there is little possibility that cracks develop at the time of assembling a sensor. Further, the solid electrolyte body 1 of each of Examples 1 to 3 and 5 had a bending strength of 300 MPa or more, and a good result was obtained. Further, the four-point bending strength in Comparative Example 1 was 400 MPa.

(Assessment of Sensor Properties)

Further, a reference electrode 32 made of Pt was formed in the inner surface which is the second surface 12 of each cup-shaped solid electrolyte body 1. Moreover, measuring electrodes 31, a lead portion, and a terminal electrode were formed in the outer surface which is the first surface 11 of the solid electrolyte body 1, and the first and second protective layers 61 and 62 were further formed. These electrodes, lead portion, and protective layers can be formed by a well-known method. In this manner, the gas sensor element S shown in FIG. 3 was prepared, and assessment of sensor reactivity of a gas sensor using the gas sensor element S was performed. Assessment tests were performed by installing a gas sensor on the exhaust flow passage of a model gas apparatus, and a model gas conditioned to have an air-fuel ratio of λ=0.90 (that is, on the rich side) by mixing carbon monoxide, methane, propane and nitrogen was used. When the model gas was supplied to the gas sensor element, the temperature of the gas was conditioned so that the temperature of the gas sensor element became 300° C., and the output voltage between the reference electrode 32 and the measuring electrodes 31 of the gas sensor element at 300° C. was measured as the rich output VR. The results are shown together in Table 1. Regarding determination criteria, it was assessed as Pass when the output was more than 0.6 V, which is the minimum output that the control circuit can determine, as Good when it was more than 0.8 V, and as Fail when it was less than 0.6 V.

As is evident from Table 1, in Comparative Example 1 where alumina cobblestones were used in the pulverizing step, the rich output was 0.5 V, and the output characteristics required of a sensor were not fulfilled. On the other hand, in Example 5 where a filtering step was performed after the pulverizing step, the rich output was 0.6 V. Moreover, in Examples 1, 3 and 4 where a filtering step was not performed, but high purity zirconia cobblestones were used, the rich output was 0.6 V to 0.8 V and the sensor properties were improved by having no particle interface impurity layer. Further, in Examples 2 and 6 where a filtering step was performed, the rich output was further improved to be in the range 0.8 V to 0.9 V.

As determination based on the results of the four point bending strength and the sensor properties are shown in Table 1, in each of Examples 1 to 6, the four point bending strength was 250 MPa or more, and the rich output was 0.6 V or more (that is, the determination was Pass). Among them, in Example 2, the four point bending strength was 300 MPa or more, and the rich output was 0.8 V, and particularly good results were obtained (that is a determination of Good). In Comparative Example 1, although the four point bending strength was high, desired sensor properties were not obtained (that is a determination of Fail).

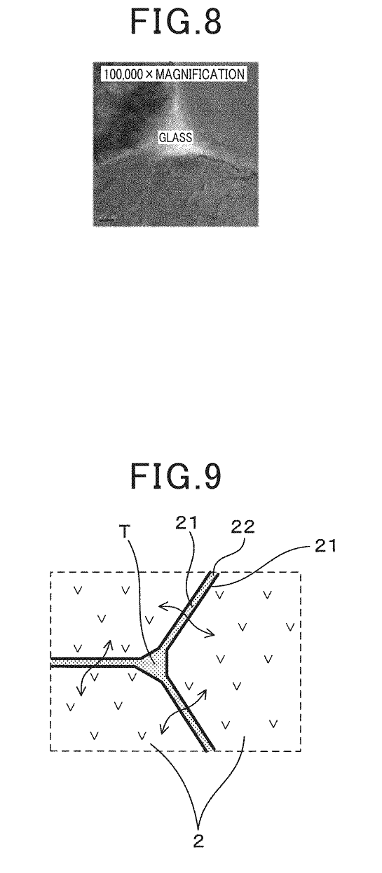

FIG. 7 shows a STEM photograph of Comparative Example 1 (that is, 20,000× magnification). Moreover, as FIG. 6 shows an enlarged photograph of region VIII of a portion thereof (that is, 100,000× magnification), white streaky particle interface impurity layers were observed in the particle interfaces 21 of the solid electrolyte particles 2. A particle interface impurity layer surrounded by three solid electrolyte particles 2 was confirmed at the particle interface triple point. As Table 3 shows the quantitative results for a plurality of analysis points 6 to 9 including the two-particle particle interface in a region shown in FIG. 8, components other than the Y component and the Zr component (that is, the Al component and the Si component) were detected. In this case, as schematically shown in FIG. 9, since the particle interface impurity layer 22 is interposed between the particle interfaces 21 of the adj oining solid electrolyte particles 2, it is estimated that ionic conduction is hindered and this reduces the sensor output.

TABLE 3

| Analysis | Analysis | Component Composition (Mass %) | | | |
|---|---|---|---|---|---|
| Point | Position | Al₂O₃ | SiO₂ | Y₂O₃ | ZrO₂ |
| 6 | Within | — | — | 13.6 | 86.4 |
| | Particle | | | | |
| 7 | Within | — | — | 14.6 | 85.4 |
| | Particle | | | | |
| 8 | Grain | 6.0 | 5.8 | 7.8 | 80.4 |
| | Boundary | | | | |
| 9 | Grain | 7.0 | 5.3 | 9.1 | 78.6 |
| | Boundary | | | | |

The present disclosure is not limited to the embodiments and Examples mentioned above, and can be applied to various embodiments in a range not departing from the substance thereof.

For example, in the embodiments mentioned above, the solid electrolyte body 1 has a constitution where the solid electrolyte body 1 only has the solid electrolyte phase M and does not contain particles other than the solid electrolyte particles 2. However, the present disclosure is not limited thereto. Specifically, it is possible to adopt a constitution including particles other than the solid electrolyte as a dispersed phase within a range not impeding the ionic conductivity of the solid electrolyte phase M. Even in such a case, it is a constitution where a particle interface impurity layer is not formed in the particle interfaces 21 between the solid electrolyte particles 2 resulting from particles to be dispersed phase, and the solid electrolyte particles 2 are in direct contact with each other, which is the same as the embodiment mentioned above, and similar effects can be obtained. Moreover, although a case of using a gas sensor element as an exhaust sensor of an internal combustion engine was described, it is possible to apply the gas sensor element to an arbitrary sensor other than an internal combustion engine or an exhaust sensor. The constitution of the gas sensor element is not limited to those shown in FIG. 4 and FIG. 5, and can be changed as appropriate.

1. A solid electrolyte body for a gas sensor element constituted by solid electrolyte particles made of zirconia containing a stabilizer, the solid electrolyte body having a solid electrolyte phase in which a large number of the solid electrolyte particles are aggregated,
wherein in the solid electrolyte phase, pairs of the solid electrolyte particles adjoining each other do not have a particle interface impurity layer between their particle interfaces, and the particle interfaces directly contact with each other.

2. The solid electrolyte body for a gas sensor element according to claim 1, wherein, in the solid electrolyte phase, the content of impurities between the particle interfaces is less than the detection limit.

3. The solid electrolyte body for a gas sensor element according to claim 1, wherein the solid electrolyte body has an ionic conductivity at 300° C. of 6×10⁻⁶ S/cm to 9×10⁻⁶ S/cm.

4. The solid electrolyte body for a gas sensor element according to claim 1, wherein the stabilizer is yttria, and the content of yttria is 4.5 mol % to 8 mol %.

5. The solid electrolyte body for a gas sensor element according to claim 1, wherein the solid electrolyte body has a four point bending strength measured by a four point bending test similar to JIS R 1601 of 250 MPa or more.

6. A method of producing the solid electrolyte body for a gas sensor element according to claim 1, comprising the steps of:
a pulverizing step of pulverizing a raw material of the solid electrolyte particles;
a slurrying step of mixing the pulverized raw material powder with a solvent to form a slurry;
a filtering step of separating impurities together with the solvent from the raw material powder by performing centrifugal separation on the obtained slurry; and
a molding step of molding the separated raw material powder into a molded body.

7. A gas sensor element using the solid electrolyte body for a gas sensor element according to claim 1,
wherein the gas sensor element is provided with a sensor body portion having the solid electrolyte body for a gas sensor element and a pair of electrodes, and
the solid electrolyte body for a gas sensor element has a measuring electrode of the pair of electrodes on a first surface contacting a gas to be measured containing a specific gas component, and a reference electrode of the pair of electrodes on a second surface contacting a reference gas.
